(19) United States
(12) Patent Application Publication
(10) Pub. No.: US 2002/0161679 A1
(43) Pub. Date: Oct. 31, 2002

(54) Method for facilitating investor participation in partnership equity offerings

(76) Inventors: Greg Randolph, Larchmont, CA (US); Ed Guay, New York, NY (US); Scott Calidas, New York, NY (US)

Correspondence Address: DREIER & BARITZ LLP, 499 PARK AVENUE, 20TH FLOOR, NEW YORK, NY, 10022, US

(21) Appl. No.: 10/035,379

(22) Filed: Oct. 26, 2001

(51) Int. Cl. G06F 17/60

(52) U.S. Cl. 705/35

(57) ABSTRACT

The present invention relates to a method for investing in a partnership comprising: (a) identifying the partnership which is the subject of an investment by an investor selected from the group consisting of at least one institutional investor, foreign investor and retail investor; (b) establishing a first class of partnership interests in the partnership, wherein the first class of partnership interests are entitled to cash distributions as defined in a partnership agreement of the partnership; (c) establishing a second class of partnership interests in the partnership, wherein the second class of partnership interests are entitled to cash distributions as defined in the partnership agreement ; and (d) to the extent where the first class of partnership interests is entitled to cash distributions and the second class of partnership interests is not, in lieu of such cash distributions, the second class receives an increased interest in the partnership interests.

### FIELD OF THE INVENTION

The present invention pertains to a method for facilitating investor participation in partnership equity offerings and, in one embodiment, the present invention pertains to a method for facilitating investment by institutional, foreign and/or retail investors in a partnership while allowing the institutional investors, foreign investors and/or retail investors to realize substantially the same financial and/or economic benefits as a direct interest holder or partner in the partnership.

### BACKGROUND OF THE INVENTION

One reason institutional investors have historically been deterred from owning equity in certain partnerships is the potentially negative tax consequences resulting from such an investment. One such type of partnership is a publicly traded partnership, which is commonly known as a master limited partnership (“MLP”).

Ownership of MLP equity typically results in nonqualifying income for regulated investment companies such as mutual funds, and unrelated business taxable income (“UBTI”) for tax-exempt organizations, such as pension funds. These institutional investors must typically limit the amount of nonqualifying income and/or UBTI which is generated in their portfolios or risk losing their tax-advantaged status. In addition, investment in MLPs, as well as in certain other partnerships, may also result in greater amounts of paperwork relating to state and/or federal tax filings and/or any accounting activities relating thereto.

In view of the foregoing, certain institutional investors, have been historically deterred from investing in MLPs and other partnerships that may result in the same or similar disadvantages as described above.

### SUMMARY OF THE INVENTION

In one embodiment, the method of the present invention facilitates investments by institutional investors, foreign investors and/or retail investors whereby an investor can invest in the equity of a partnership such as an MLP without being burdened by the economic, administrative, and/or tax disadvantages which have typically been associated therewith.

The method of the present invention involves a partnership which is the subject of the investment or investments. The partnership can be any partnership entity which can include, but which is not limited to, a general partnership, a limited partnership, a limited liability company which is taxed as a partnership for tax purposes, and/or an MLP.

In yet another embodiment, the method of the present invention can also involve a management company or management corporation which can be, but which is not limited to, any company, corporation, limited liability company, etc., which can invest in the partnership. The equity of the management company can be represented by shares or membership interests.

In a further embodiment, the method of the present invention can also involve institutional investors which can include, but which is not limited to, mutual funds, pension funds, investment trusts, financial institutions, financial intermediaries, etc., which desire to invest in the partnership via the management company.

In yet a further embodiment, the method of the present invention can also involve retail investors which can include individual investors, investment entities or organizations, and/or any other non-institutional investment entities or organization, who or which desire to indirectly invest in the partnership via the management company.

In yet a further embodiment, the method of the present invention can also involve foreign institutional and/or foreign retail investors that can include individual investors, investment entities or organizations, and/or any other non-institutional investment entities or organization, who or which desire to indirectly invest in the partnership via the management company.

In another embodiment, the method of the present invention can also involve a partnership that can be owned partially by a parent company or parent corporation.

In one example, the method of the present invention can be utilized in order to facilitate institutional and/or retail investment in a partnership of any kind and/or any business entity which is taxed as a partnership. In another example, the method of the present invention can also be utilized in applications involving mergers and/or acquisitions that form partnerships, business entities taxed as partnerships.

In a specific embodiment, the method of the present invention can commence with the identification of a partnership that is the subject of the investment. In one example, partnership ownership can be represented by partnership-interests. A management company can be established which can be any entity which is taxed as a corporation. The management company can manage the operations of the partnership as well as invest in the partnership. Ownership of the management company can be represented by shares of stock in same. In one embodiment, the management company can also be a publicly traded company.

In another embodiment, the management company, upon receiving the investment capital from the issuance of its shares, can establish a cash reserve fund account with a portion of the received proceeds. The reserve fund can be utilized by the management company in order to provide capital for the redemption of its shares.

In yet another embodiment, the management company can invest at least a portion of the proceeds received from the issuance of its shares in the partnership and receive partnership interests in exchange for its investment. For example, the ratio of the number of shares issued from the management company to the number of the partnership interests owned by the management company can be pre-selected to be any appropriate ratio (e.g. 1:1, 2:1, 1:2).

In another embodiment, the general partner of the partnership delegates management responsibility of partnership operations to the management company (e.g. company manages the affairs of the partnership).

In a further embodiment, upon the occurrence of a cash distribution event from the partnership, a determination can be made in order to determine whether the partnership interests are held by the management company or another investor. In another embodiment, the distribution event may consist of cash, or in the alternative, other assets or any combination of the three. The cash distribution can be made to each partner in a manner consistent with each partner's relative partnership interest in the partnership. If it is determined that the partnership interest is held by the management company, then the number of partnership interests which are to be paid as an in-kind distribution(s) to the management company can be determined in lieu of a cash distribution. The in-kind distribution(s) can be determined based upon the number of partnership interests held by the management company. The number of partnership interests which are paid out as an in-kind distribution can be determined in any appropriate manner. For example, the in-kind distribution can be determined by dividing the cash distribution allocated to the partnership interests by the average daily closing price of the shares of the management company for a pre-selected number of trading days prior to the day before the ex-distribution date of the distribution.

In one embodiment, the partnership can distribute the partnership interests to the management company as a distribution(s). In another embodiment, the partnership can also be required to reinvest the cash which would have otherwise been distributed to the management company, back into its business.

In a further embodiment, the management company can, in turn, distribute shares in the management company to each of the institutional investors, foreign investors and/or retail investors according to the respective number of shares held by each investor so as to meet the preselected ratio of management company shares to the number of the partnership interests owned by the management company. In a specific embodiment, the account(s) of each institutional investor and/or each retail investor can then be updated to reflect the respective investor's updated position or holdings in the shares of the management company. Thereafter, the above-described method can be repeated for a subsequent distribution event.

In accordance with the present invention, the payment of any of the in-kind stock dividends, as shares of the management company, should result in no U.S. taxable income to the institutional investors, foreign investors and/or retail investors. The method of the present invention also should result in no U.S. non-qualified income and/or no unrelated business taxable income being received by the respective institutional investors, foreign investors and/or retail investors. The method of the present invention can also prevent the investors of the management company from receiving K-1's from the partnership.

### BRIEF DESCRIPTION OF THE DRAWINGS

In the Drawings:

FIG. 1 illustrates the entities involved in an embodiment use of the method of the present invention, in block diagram form;

FIG. 2 illustrates the entities involved in another embodiment use of the method of the present invention, in block diagram form;

FIGS. 3A and 3B illustrate an embodiment method for utilizing the method of the present invention, in flow diagram form;

FIG. 4 illustrates the entities involved in an embodiment use of the method of the present invention wherein the method of the present invention is utilized in conjunction with facilitating investment in a master limited partnership; and

FIGS. 5A and 5B illustrate another embodiment method for utilizing the method of the present invention for facilitating investment in a master limited partnership, in flow diagram form.

### DESCRIPTION OF THE EMBODIMENTS

The present invention is directed to a method for facilitating investor ownership in partnership equity. The method of the present invention can facilitate such investments by institutional investors, foreign investors and/or retail investors by providing a mechanism by which an investor can invest in the equity of a partnership and/or an MLP without being burdened by the administrative, and/or tax, shortfalls and disadvantages which have typically been associated therewith.

As defined herein, the terms “partnership,” or the plural of same, refer to any business entity which includes at least two individuals or entities conducting business as a partnership and/or any business entity which is taxed as a partnership.

As defined herein, the terms “master limited partnership,” “MLP,” or the plural of same, refers to any entity that is structured as, characterized by, and/or enjoys the benefits of, an MLP that include, but are not limited to, being publicly traded while enjoying the benefits under Section 7704 of the United States Internal Revenue Code (or its equivalence) of being taxed as a partnership.

As defined herein, the terms “institutional investor,” or the plural of same, refer to any one or more of institutional investors, mutual funds, pension funds, investment trusts, financial institutions, financial intermediaries, and/or any other institutional investors or investment entities, etc., which utilize the method of the present.

As defined herein, the terms “retail investor,” or the plural of same, refer to any individual investors who or which utilize the method of the present invention.

As defined herein, the terms “MC-Corp share,” “MC-Company share,” “MC-share,” or the plural of same, refer to shares of stock which represent equity ownership in the management company described herein as being involved in the method of the present invention, and which are purchased by the institutional investors, foreign investors and/or retail investors described herein.

As used herein, the term “second class” interests, shares or units is meant only to differentiate the class from another class of interests, shares or units and is not meant to limit the class to a lower status than other classes or to the date of issuance.

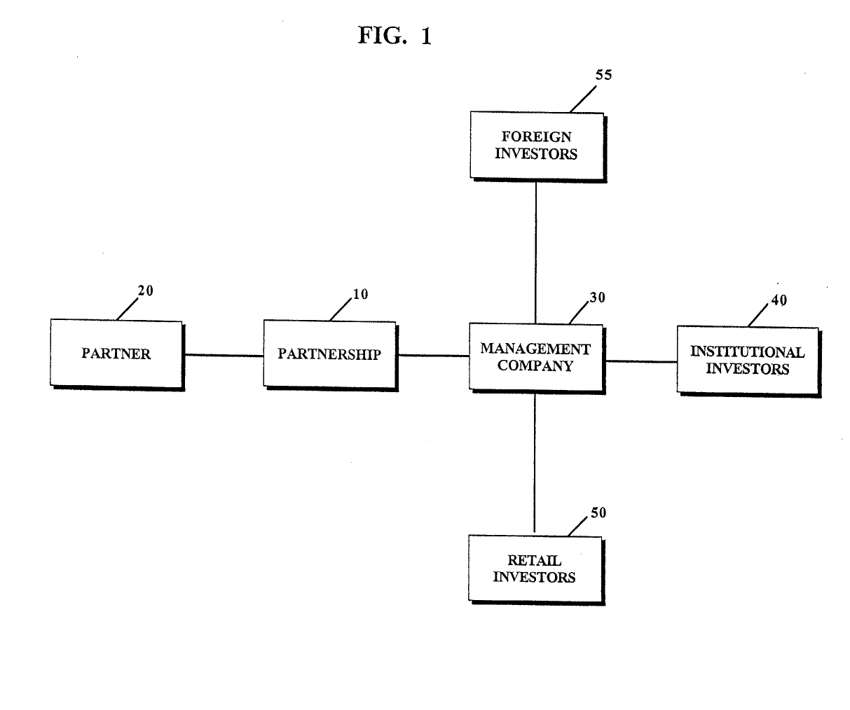

FIG. 1 illustrates the entities involved in one embodiment of the method of the present invention, in block diagram form. With reference to FIG. 1, the method of the present invention involves a partnership 10 that is the subject of the investment or investments described herein.

The partnership 10 can be any partnership business entity that can include, but which is not limited to, a general partnership, a limited partnership, a limited liability company and/or an MLP, etc. A partnership is owned by its partners (hereinafter referred to as “partner 20”).

For purposes of the present illustration, the partnership interest in the partnership 10 is represented by any one or more of partnership interests, partnership units, and/or partnership shares (hereinafter referred to as “partnership interests” or “P-interests”) which are held by the respective partners 20 in their respective ownership percentages.

With reference once again to FIG. 1, the method of the present invention also involves a management corporation or management company 30 (also referred to as “MC-Corp 30”, “management company 30”, or “MC-Company 30”). The management company 30 can be, but is not limited to, any company, corporation, limited liability company, etc., which can invest in the partnership 10 by utilizing the method of the present invention.

The partnership interest and/or equity of the management company 30 are represented in shares of ownership and/or stock shares (hereinafter referred to as “MC-shares”). For example, an investor can purchase an interest in the management company 30 by purchasing MC-shares.

With reference once again to FIG. 1, the method of the present invention involves institutional investors 40 which can include, but which are not limited to, mutual funds, pension funds, investment trusts, financial institutions, financial intermediaries, etc., which invest in the partnership 10 via the management company 30 pursuant to the method of the present invention. The method of the present invention can also involve retail investors 50 which can include individual investors, investment entities or organizations, and/or any other non-institutional investment entities or organizations, who or which invest in the partnership 10 via the management company 30 pursuant to the method of the present invention. The method of the present invention can also involve foreign investors 55 which can include individual investors, retail investors, investment entities or organizations, and/or institutional investment entities or organizations, who or which invest in the partnership 10 via the management company 30 pursuant to the method of the present invention.

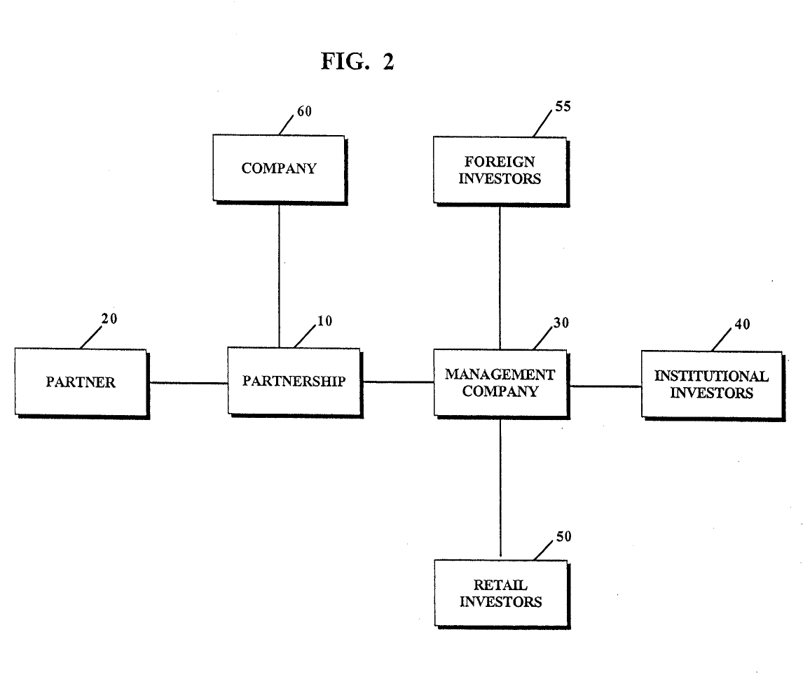

In another embodiment, the method of the present invention can involve a partnership 10 that is owned partially by a company. FIG. 2 illustrates another embodiment of the present invention wherein the partnership 10 is owned at least in part by a company (hereinafter referred to as the “company 60”) that is an additional partner in the partnership. With reference to FIG. 2, the method of the present invention can involve any one or more of the partnership 10, the partner 20, the management company 30, the institutional investors 40, foreign investors 55 and the retail investors 50, which are described above with reference to FIG. 1.

In one specific embodiment, the method of the present invention can be utilized in order to facilitate institutional and/or retail investment in a partnership of any kind and/or any business entity which is taxed as a partnership. The method of the present invention can also be utilized in applications involving mergers and/or acquisitions that form, or result in, partnerships, business entities taxed as partnerships.

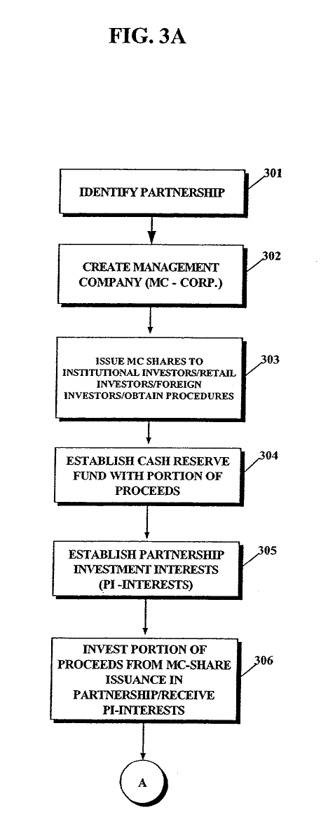

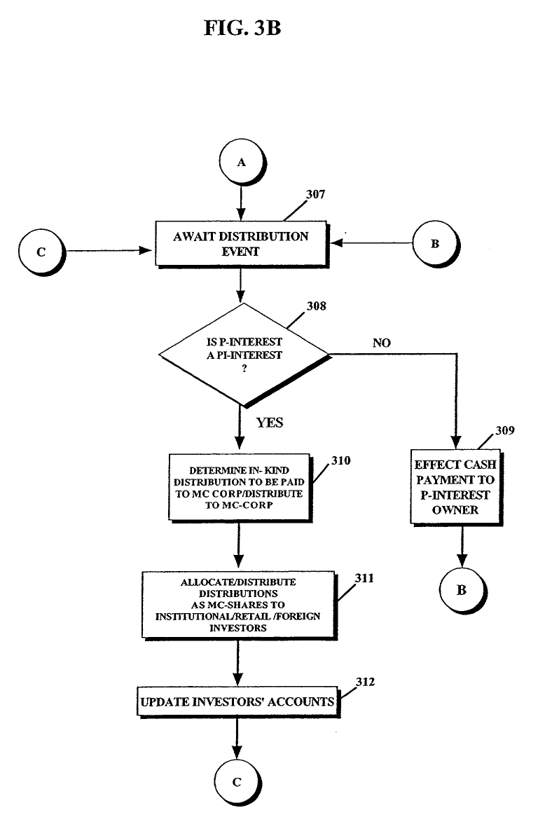

FIGS. 3A and 3B illustrate an embodiment method for utilizing the method of the present invention in order to facilitate investment in a partnership 10 by institutional investors 40 and/or retail investors 50 and/or foreign investors 55. In this embodiment, these institutional investors, foreign investors and/or retail investors would, but for the method of the present invention, be deterred for various financial, administrative, and/or tax reasons, from investing directly in the partnership 10.

With reference to FIGS. 3A and 3B, the method of the present invention commences at step 301 with the identification of the partnership 10. The ownership of the partnership 10, in the embodiment of FIGS. 3A and 3B, is represented by partnership interests (“P-interests”). As will be described below, in one embodiment, ownership in the partnership by a management company 30 can be represented by a second class of partnership interests (“PI-interests”). The PI-interest is essentially a P-interest which is owned by the management company 30.

At step 302, the management company 30 can be established. In an embodiment of the present invention, the management company 30 can be, but is not limited to, a corporation, a limited liability company (“LLC”), or any other company or business entity that is taxed as a corporation. The management company 30, in an exemplary embodiment, is typically a management corporation 30 (hereafter referred to as “MC-Corp 30”) that manages the operations of the partnership 10 and that provides investment capital to the partnership 10.

The ownership of the MC-Corp 30 is represented by shares of stock in the MC-Corp 30 which shares of stock are hereinafter referred to as “MC-shares”. In one embodiment, the MC-Corp 30 is a publicly traded company that registers its MC-shares with the SEC and lists them on an exchange. The traded nature of the MC-shares of the MC-Corp 30 can facilitate investment by the institutional investors 40, foreign investors 55, and/or by the retail investors 50 in the manner described herein.

At step 303, the MC-Corp 30 can issue its MC-shares to institutional investors 40, such as, but not limited to, mutual funds, pension funds, financial institutions, financial intermediaries, as well as any other institutional investment entity or entities which would normally be deterred, for any reason, from investing directly in the partnership 10. At step 303, the MC-Corp 30 can also issue its MC-shares to retail investors 50 (e.g. individual investors or individual retirement accounts (“IRA's”)) who or which, but for the method of the present invention, may also be deterred from investing directly in the partnership 10.

In another embodiment, at step 304, the MC-Corp 30, upon receiving the investment capital from the institutional investors 40 and/or the retail investors 50 and/or foreign investors 55, can establish a cash reserve fund account with a portion of the capital raised from the MC-share issuance. The reserve fund can be funded with any desired or suitable portion or percentage of the proceeds raised from the issuance of the MC-shares. In one embodiment, the reserve fund can be funded with, for example, 20% of the proceeds raised from the MC-share issuance.

In other embodiments, the reserve fund can be funded with any suitable and/or appropriate portion or percentage of the proceeds raised from the MC-share issuance. In an embodiment of the present invention, the reserve fund can be utilized in order to provide capital for the redemption of MC-shares. In this manner, the MC-Corp 30 will provide a fund from which the shares of any of the institutional investors 40 and/or retail investors 50 and/or foreign investors 55 could be redeemed. It is understood that this reserve fund is another embodiment and thus, is not required for other embodiments of the present invention.

At step 305, the partnership 10 can establish a class of equity interests as partnership-investment interests (hereinafter referred to as “PI-interests”). In an embodiment of the present invention, the PI-interests will not generally be allocated any taxable income or loss generated by the partnership except in the event of the liquidation of the partnership.

At step 306, the MC-Corp 30 will invest at least a portion of the proceeds received from the MC-share issuance in the partnership 10 and receive PI-interests, representing ownership in the partnership 10, in exchange for the investment. In one embodiment, where the MC-Corp 30 invests all of the proceeds received from the MC-share issuance in the partnership 10 and receive PI-interests, the MC-Corp 30 can maintain a one to one (1:1) ratio between the number if MC-shares which are issued by the MC-Corp and the number of PI-interests which are owned or held by the MC-Corp 30.

At step 306, the general partner of the partnership 10 delegates control of the partnership operation to the MC-Corp 30, to the extent permitted. In one embodiment, at step 307, the method of the present invention is triggered by a distribution event. The distribution event, in an embodiment of the present invention, can occur at any suitable or appropriate time or time interval, at quarterly intervals, at semi-annual intervals, at annual intervals, and/or upon the occurrence of any pre-specified event(s) (e.g. 45 days after a fiscal quarter), as determined by the MC-Corp management and/or within the discretion of the MC-Corp management.

Upon the occurrence of the cash distribution event, the method of the present invention will proceed to step 308 and determine if a respective P interest is a PI interest signifying ownership of the P interest by the MC-Corp 30. If, at step 308, it is determined that the P interest is a P interest held by a partner (other than MC-Corp) of the partnership 10, the method will proceed to step 309 and the partnership 10 will effect payment of the cash distribution(s) to the holder of the P interest(s). If it is determined to be held by a partner (other than MC-Corp), the appropriate cash distribution(s), for all of the partnership interests held by the particular partner, will be distributed to the partner. In one example, the cash distribution(s) can be distributed to each partner in a manner consistent with each partner's relative partnership interest in the partnership. Thereafter, the method will return to step 307 and await the next distribution event.

If, at step 308, it is determined that the P interest is a PI interest held by the MC-Corp 30 pursuant to the method of the present invention, the method will proceed to step 310. At step 310, the partnership 10 will determine the number of PI-interests that are to be paid as an in-kind distribution(s) to the MC-Corp 30 in lieu of a cash distribution based on the number of PI-interests held by the MC-Corp 30.

In one specific example, the number of PI-interests that are distributed to the MC-Corp 30, as an in-kind distribution(s), can be determined in the following manner. Since, in this example, the ratio of PI-interests to MC-shares is 1:1 and the MC-shares publicly traded, the number of PI-interests to be paid out as in-kind distribution(s) to the MC-Corp 30 can be determined by dividing the cash distribution to which each PI interest is entitled by the average daily closing price of the MC-share for a pre-selected number of trading days prior to the date of the distribution. In this example, an equal number of MC-shares would then be distributed to MC-shareholders, thereby maintaining a 1:1 ratio of PI interests to MC-shares..

For example, the pre-selected number of days can be, but is not limited to, ten (10) days. Then, if a $1.00 per P interest cash distribution is declared by the partnership 10, and the average price of the MC-share is $0.80 for the ten trading days prior to the day before the ex-distribution date of the distribution, the in-kind distribution in PI-interests to the MC-Corp 30 will be 1.25 interests, and therefore, the MC-share distribution to each institutional investor 40, foreign investor 55 and/or retail investor 50 will be 1.25 MC-shares for each MC-share held by the respective investor.

In another example, if a $1.00 per P interest cash distribution is declared by the partnership 10, and the average price of the MC-share is $1.25 for the ten trading days prior to the day before the ex-distribution date of the distribution, the in-kind distribution in PI-interests to the MC-Corp 30 will be 0.8 interests, and therefore, the MC-share distribution will be 0.80 MC-shares for each MC-share held by the respective investor. Fractional shares which, while not always being tradable by themselves, can also be distributed as part of the in-kind distribution(s). Alternatively, the shares to be distributed could be rounded up or down in any manner.

At step 310, the partnership 10 will distribute the in-kind PI-interests as distributions to the MC-Corp 30. The partnership 10 can be required to reinvest the cash, which would have otherwise been paid out to the MC-Corp 30 as a distribution, back into its business.

At step 311, the MC-Corp receives the additional PI-interests and the MC-Corp 30 will, in turn, allocate and distribute the in-kind MC-share distributions to each of the institutional investors 40, foreign investors 55 and/or retail investors 50 according to the respective number of MC-shares held by each investor. For example, if an institutional investor 40 holds 10,000 MC-shares and a cash distribution of $1.00 per P interest is declared, the institutional investor 40 will receive, for a calculated average MC-share price of $1.25, 8,000 additional MC-shares as an in-kind distribution payment.

At step 312, the account of each institutional investor 40 and/or each retail investor 50 and/or foreign investor 55 can be updated to reflect the respective investor's updated MC-shares position or holdings. Thereafter, the method of the present invention will proceed to step 307 and await the next distribution event. The above-described method steps 307 through 312 can be respectively repeated until distributions have been made to all of the respective P interest holders in the partnership 10 and to all of the respective PI interest holders in the partnership 10.

The payment of the MC-share stock distribution, pursuant to the method of the present invention, should result in the realization of no United States taxable income as a result of that distribution to the institutional investor(s) 40 and/or retail investor(s) 50. Instead, a portion of the respective MC-share holder's existing tax basis will be allocated among the additionally distributed MC-shares. If and when the MC-share holder sells its MC-shares, it may recognize capital gains. In addition, the additional shares distributed as a result of the MC-share stock distribution would be entitled to the benefit of the holding period of the initial stock purchase.

In addition, the method of the present invention results in no allocation of nonqualifying U.S. income and/or unrelated business taxable income to the MC-Corp.'s respective investors. For the investors who own MC-shares,the utilization of the method of the present invention also dispenses with the need to issue K-1 statements to any of the institutional investors 40 and/or retail investors 50.

In another embodiment of the present invention, the partnership 10, general partner, or other party can be required to indemnify the MC-Corp 30 for any tax consequences which may result from any activity of the partnership 10 and/or from any of the investments described herein. The MC-Corp 30 can also, in another embodiment, be limited in its ability to sell or redeem PI-interests where such a sale or redemption may trigger taxable events for the MC-Corp 30. In another embodiment, put rights may be provided and/or allocated to the institutional investors 40, foreign investor 55 and/or retail investors 50 in the event of a liquidation of the partnership 10 and/or the MC-Corp 30.

In one embodiment, the MC-share holders enjoy no voting rights other than those limited voting rights analogous to those that may be granted to limited partners of the partnership 10. In such an embodiment, the MC-Corp may be controlled through a super-voting interest held by a partner in the partnership. For example, in instances where a company 60 is a partner in the partnership 10, that company 60 can hold the super-voting rights and, therefore, the ability to control the MC-Corp 30.

In one embodiment, the MC-shares can be exchangeable at any time by its respective holder(s) into P interests on a one-for-one basis and/or pursuant to any other ratio. In another embodiment, the investor can deliver MC-shares for P interests and the general partner, or any other entity facilitating such exchange, has the option to deliver cash and/or P-interests. The MC-Corp 30 can, at its option, deliver cash in lieu of P-interests equal to the market value of the P-interests that could have been received.

In the above described manner, the method of the present invention facilitates institutional investor and/or retail investor investments in partnerships, while providing the respective investor with more favorable tax treatment, simpler paperwork and/or accounting activities and/or practices, and/or enhanced aftermarket liquidity in the securities relating to partnerships.

In one application, the method of the present invention can be utilized in order to facilitate investment in an MLP by institutional investors, foreign investors and/or by retail investors. The partnership interest in the MLP can be represented by MLP-interests. The method of the present invention can permit investors to realize similar economic, benefits as an MLP interest holder without resulting in the tax issues (e.g. recognition by that investor of nonqualifying income and/or unrelated business taxable income (UBTI)) and administrative matters which are typically associated with direct ownership in an MLP.

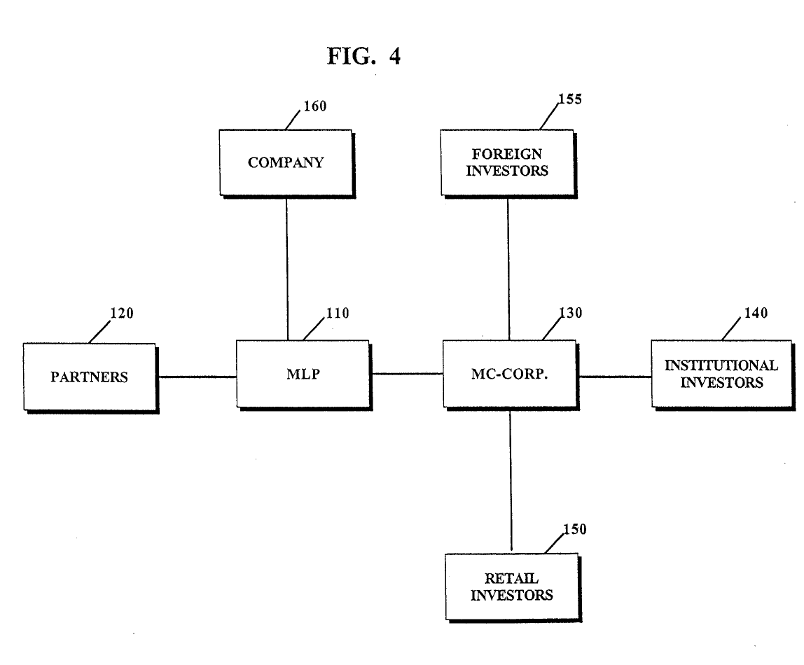

FIG. 4 illustrates the entities that can be involved in an embodiment wherein the method of the present invention can be utilized in order to facilitate investments by institutional investors, foreign investors and/or retail investors in an MLP. With reference to FIG. 4, the method of the present invention involves a master limited partnership 110 (MLP 110) that is the subject of the investment or investments described herein. In one embodiment, the MLP 110 can be any publicly traded partnership. The MLP 110 is owned by its partners (hereinafter referred to as “partners 120”).

The partnership interest in the MLP 110 is represented by any one or more of MLP partnership interests, MLP partnership points, and/or MLP partnership shares, (hereinafter referred to as “MLP partnership interests” or “MLP-interests”) which are held by the respective partners 120 in their respective ownership percentages. As will be described herein below, MLP-interests can also include MLP investment interests (“MLPI-interests”) that will represent ownership in the MLP by a management company. The MLPI-interests are, in essence, an MLP-interest that is owned or held by an management company.

With reference once again to FIG. 4, in another embodiment, the MLP 110 can also be partially owned by a company 160 (hereinafter “company 160”). The method of FIG. 4 can also include the above-described management company 130 (hereinafter also referred to as “MC-Corp 130”).

The MC-Corp 130 can be, but is not limited to, any company, corporation, limited liability company, etc., which can invest in the MLP 110 by utilizing the method of the present invention. The equity interests of the MC-Corp 130 are represented by shares of ownership which are hereinafter referred to as “MC-shares”.

With reference once again to FIG. 4, the method of the present invention also involves institutional investors 140 which can include, but which are not limited to, mutual funds, pension funds, investment trusts, financial institutions, financial intermediaries, etc., which indirectly invest in the MLP 110 via the MC-Corp 130 pursuant to the method of the present invention. The method of the present invention can also involve retail investors 150 which can include individual investors, investment entities or organizations, and/or any other non-institutional investment entities or organizations, who or which indirectly invest in the MLP 110 via the MC-Corp 130 pursuant to the method of the present invention. The method of the present invention can also involve foreign investors 155 which can include individual investors, investment entities or organizations, and/or institutional investment entities or organizations, who or which indirectly invest in the MLP 110 via the MC-Corp 130 pursuant to the method of the present invention.

In one application, the method of the present invention can be utilized in order to facilitate institutional, foreign and/or retail investment in an MLP 110. The MLP 110 can operate in any suitable business field, which can include, but not be limited to, the extraction, transportation, processing and/or storage of natural resources or other activities listed in Section 7704 of the U.S. Internal Revenue Code.

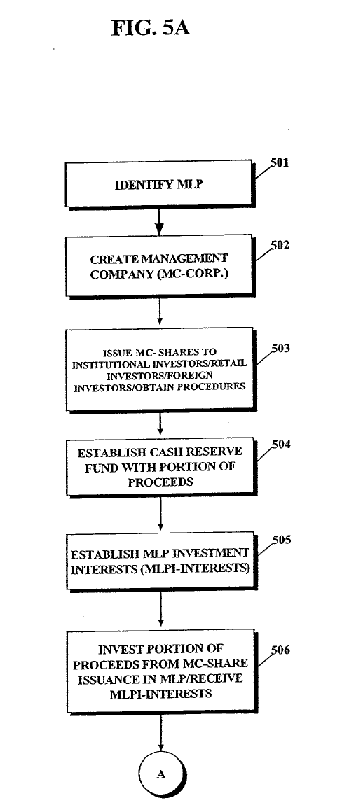

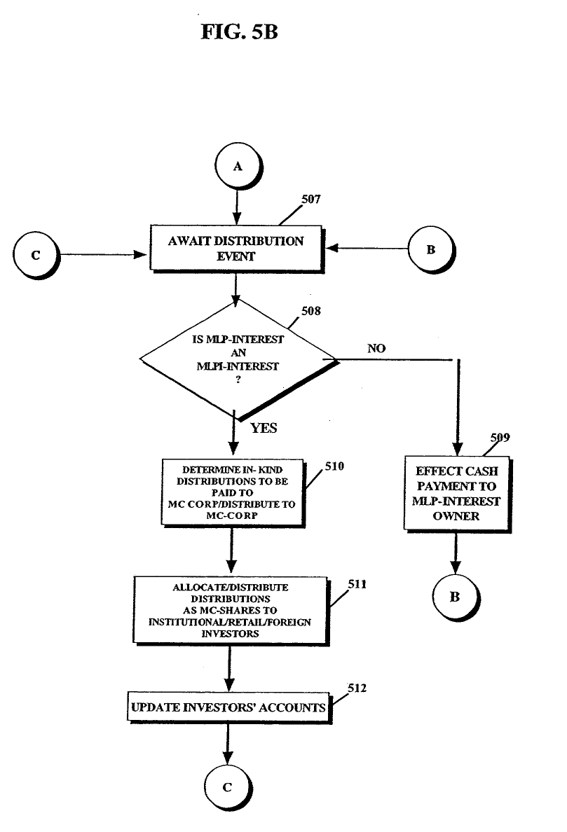

FIGS. 5A and 5B illustrate an embodiment method for utilizing the method of the present invention in order to facilitate investment in a MLP 110 by institutional investors 140 and/or retail investors 150 and/or foreign investors 155. In this embodiment, these institutional investors 140 and/or retail investors 150, for one reason or another, would, but for the method of the present invention, be deterred for various economic, administrative and/or tax reasons, from investing directly in the MLP 110.

With reference to FIGS. 5A and 5B, the method of the present invention commences at step 501 with the identification of the MLP 110. In one embodiment, the MLP 110 can, for example, be an MLP that is engaged in the extraction, transportation, processing and/or storage of natural resources or other activities listed in Section 7704 of the U.S. Internal Revenue Code. The ownership of the MLP 110, in the embodiment of FIGS. 5A and 5B, is represented by MLP-interests. As noted above, ownership in the MLP 110 by the MC-Corp 130 is represented by MLPI-interests.

At step 502, the MC-Corp 130 is established. In an embodiment of the present invention, the MC-Corp 130 can be, but is not limited to, a corporation, a limited liability company (“LLC”), or any other company or business entity which is taxed as a corporation. The MC-Corp 130, in an exemplary embodiment, is typically a management company which can manage the operations of the MLP 110 and which can also provide investment capital to the MLP 110.

As noted above, the ownership of the MC-Corp 130 is represented by MC-shares. In one embodiment, the MC-Corp 130 is a publicly traded company that issues its MC-shares to the public. The publicly traded nature of the MC-Corp 130 and of its MC-shares can facilitate investment by the institutional investors 140, by the retail investors 150 and by the foreign investors 155 in the manner described herein.

At step 503, the MC-Corp 130 can issue its MC-shares to institutional investors 140, such as, but not limited to, mutual funds, pension funds, financial institutions, financial intermediaries, as well as any other institutional investment entity which may or may not be deterred, for any reason, from investing in the MLP 110. At step 503, the MC-Corp 130 can also issue its MC-shares to retail investors (e.g. individual investors or individual retirement accounts (“IRA's”)) 150 who or which, but for the method of the present invention, may or may not be deterred from investing in the MLP 110.

In another embodiment, at step 504, the MC-Corp 130, upon receiving the investment capital from the institutional investors 140 and/or the retail investors 150 and/or foreign investors 155, can establish a reserve fund account with at least a portion of the proceeds raised from the MC-share issuance. The reserve fund can be funded with any desired or suitable portion or percentage of the proceeds raised from the issuance of the MC-shares. In one embodiment, the reserve fund can be funded with, for example, 20% of the proceeds raised from the MC-share issuance. It is understood that an establishment of a reserve fund is not required.

In other embodiments, the reserve fund can be funded with any suitable and/or appropriate portion or percentage of the proceeds raised from the MC-share issuance. In an embodiment of the present invention, the reserve fund can be utilized in order to provide capital for the redemption of MC-shares. In this manner, the MC-Corp 130 will provide a fund from which the shares any of the institutional investors 140 and/or retail investors 150 can be redeemed.

At step 505, the MLP 110 can establish a class of equity interests as MLP investment interests (hereinafter referred to as “MLPI-interests”). In an embodiment of the present invention, the MLPI-interests will generally not be allocated income, gain, loss or deductions of the MLP.

At step 506, the MC-Corp 130 will invest at least a portion of proceeds received from the MC-share issuance in the MLP 110 and receive MLPI-interests, representing ownership in the MLP 110, in exchange for the investment. In one embodiment, where the MC-Corp 30 invests all of the proceeds received from the MC-share issuance in the partnership 10 and receive MLPI-interests, the MC-Corp can maintain a one to one (1:1) ratio between the number of MC-shares that are issued by the MC-Corp 130 and the number of MLPI-interests which are owned or held by the MC-Corp 130.

At step 506, the general partner of the MLP 110 can also delegate, to the extent permitted, all of its rights and powers to manage and control the business and affairs of the MLP to the MC-Corp 130. At step 507, the method of the present invention will await a distribution event. The distribution event, in an embodiment of the present invention, can occur at any suitable or appropriate time or time interval, at quarterly intervals, at semi-annual intervals, at annual intervals, and/or upon the occurrence of any pre-specified event(s), as determined by the MC-Corp management and/or within the discretion of the MC-Corp management, subject to any requirements imposed by the MLP's partnership requirement.

Upon the occurrence of the cash distribution event, the method of the present invention will proceed to step 508 and determine if an MLP-interest is an MLPI-interest signifying ownership of the MLP-interest by the MC-Corp 130.

If, at step 508, it is determined that the MLP-unit is an MLP-unit held by a partner (other than MC-Corp) of the MLP 110, the method will proceed to step 509 and the MLP 110 will effect payment of the cash distribution(s) to the holder of the MLP-interest(s). The appropriate cash distribution(s), for all of the partnership interests held by the particular partner, will be distributed to the partner. The cash distribution(s) can be made to each partner in a manner consistent with the terms of the MLP's partnership agreement. Thereafter, the method will return to step 507 and await a next distribution event.

If, at step 508, it is determined that the MLP-unit is an MLPI-interest held by the MC-Corp 130 pursuant to the method of the present invention, the method will proceed to step 510. At step 510, the MLP 110 will determine the number of MLPI-interests that are to be paid as an in-kind distribution(s) to the MC-Corp 130 based on the number of MLPI-interests held by the MC-Corp 130.

In one embodiment, the number of MLPI-interests that are paid out to the MC-Corp 130 as an in-kind distribution(s) can be determined in the following manner. Since, in this example, the ratio of MLPI-interests to MC-shares is 1:1 and the MC-shares are publicly traded, the number of MLPI-interests to be paid out as an in-kind distribution(s) to the MC-Corp 130 can be determined by dividing the cash distribution to which each MLPI-unit is entitled by the average daily closing price of the MC-share for a pre-selected number of trading days prior to the distribution date of the distribution.

In one embodiment, the pre-selected number of days can be, but is not limited to, ten (10) days. For example, if a $1.00 per MLP-interest cash distribution is declared by the MLP 110, and the average price of the MC-share is $0.80 for the ten trading days prior to the day before the ex-distribution date of the distribution, the in-kind distribution in MLPI-interests to the MC-Corp 130 will be 1.25 interests, and therefore, the MC-share distribution to each institutional investor 140 and/or retail investor 150 will be 1.25 MC-shares for each MC-share held by the respective investor.

In another example, if a $1.00 per MLP-interest cash distribution is declared by the MLP 110, and the average price of the MC-share is $1.25 for the ten trading days prior to the day prior to the day before the ex-distribution date of the distribution, the in-kind distribution in MLPI-interests to the MC-Corp 130 will be 0.8 interests, and therefore, the MC-share distribution to each institutional investor 140 and/or retail investor 150 will be 0.80 MC-shares for each MC-share held by the respective investor. Fractional shares which, while not always being tradable by themselves, can also be paid out as part of the in-kind distributions.

At step 510, the MLP 110 distributes the in-kind MLPI-interests as distributions to the MC-Corp 130. The MLP 110 is required to retain the cash, which would have otherwise been paid out to the MC-Corp 130 as a distribution.

At step 511, the MC-Corp 130 will, in turn, distribute the in-kind MC-share distributions to each of the institutional investors 140 and/or retail investors 150 and/or foreign investors according to the respective number of MC-shares each investor holds. For example, if an institutional investor 140 holds 10,000 MC-shares and a cash distribution of $1.00 per MLP-unit is declared, the institutional investor 140 will receive, for a calculated average MC-share price of $1.25, 8,000 additional MC-shares as an in-kind distribution payment.

At step 512, the account of each institutional investor 140 and/or each retail investor 150 can be updated to reflect the respective investor's updated MC-shares position or holdings. Thereafter, the method of the present invention will proceed to step 507 and await the next distribution event. The above-described method steps 507 through 512 can be respectively repeated until distributions have been made to all of the respective MLP-unit holders in the MLP 110 and all of the respective MLPI-unit holders in the MLP 110.

The payment of the MC-share stock distribution(s), pursuant to the method of FIGS. 5A and 5B, should result in no U.S. tax consequences to the institutional investor(s) 140, foreign investor(s) 155 and/or retail investor(s) 150. Instead, a portion of the respective MC-share holder's tax basis will be allocated among the additionally distributed MC-shares. If and when the MC-share holder sells its/his/her MC-shares, it/he/she should recognize capital gains.

In addition, the method of the present invention should result in no allocation of U.S. nonqualifying income and/or unrelated business taxable income to the MC-Corp.'s respective investors.

The utilization of the method of the present invention should also result in no K-1's being received by MC-Corp's investors.

In another embodiment of the present invention, the MLP 110 or another entity can be required to indemnify the MC-Corp 130 for any tax liability that may result from any activity of the MLP 110 and/or the MC-Corp and/or from any of the investments described herein. The MC-Corp 130 can also, in another embodiment, be limited in its ability to sell or redeem MLPI-interests where such a sale or redemption may trigger taxable events for the MC-Corp. In another embodiment, put rights may be provided and/or allocated to the institutional investors 140 and/or retail investors 150 and/or foreign investors 155 in the event of a liquidation of the MLP 110 and/or the MC-Corp 130.

In one embodiment, the MC-share holders can enjoy no voting rights other than those limited voting rights analogous to those that may be granted to limited partners of the MLP 110. In such an embodiment, the MC-Corp 130 may be controlled through a super-voting interest. For example, in instances when a parent company is a partner in the MLP, that parent company can hold the super-voting rights and, therefore, the ability to control the MC-Corp 130.

In one embodiment, the MC-shares can be exchangeable at any time by its respective holder into MLP-interests on a one-for-one basis, and/or pursuant to any other ratio, and/or the investor can deliver shares for interests. The general partner or any other entity can then have the option to deliver cash and/or interests. The entity can, at its option, deliver cash in lieu of MLPI-interests equal to the market value of the MLPI-interests.

In the above described manner, the method the present invention facilitates institutional investor and/or retail investor and/or foreign investors investments in MLPs, while providing the respective investors with one or more of the following: more favorable tax treatment, simpler paperwork and/or accounting activities and/or practices, and/or enhanced aftermarket liquidity in the securities relating to MLPs than such investor would otherwise realize from a direct investment in the MLP.

While the present invention has been described and illustrated in various embodiments, such descriptions are merely illustrative of the present invention and are not to be construed to be limitations thereof. In this regard, the present invention encompasses all modifications, variations and/or alternate embodiments with the scope of the present invention being limited only by the claims which follow.

What is claimed is:

1. A method for investing in a partnership comprising:
(a) identifying the partnership which is the subject of an investment by an investor selected from the group consisting of at least one institutional investor, foreign investor and retail investor;
(b) establishing a first class of partnership interests in the partnership, wherein the first class of partnership interests are entitled to cash distributions as defined in a partnership agreement of the partnership;
(c) establishing a second class of partnership interests in the partnership, wherein the second class of partnership interests are entitled to cash distributions as defined in the partnership agreement; and
(d) to the extent where the first class of partnership interests is entitled to cash distributions and the second class of partnership interests is not, in lieu of such cash distributions, the second class receives an increased interest in the partnership interests.

2. The method of claim 1 comprising the additional step of:
establishing at least one corporation for investing in the partnership, wherein ownership in the corporation is represented at least in part by publicly traded shares, wherein the corporation issues the shares to the investor, and further wherein the corporation receives cash proceeds from the share issuance.

3. The method of claim 2 wherein at least a portion of the received cash proceeds by the corporation are invested into the partnership in exchange for the second class of partnership interests.

4. The method of claim 3 wherein the increasing interest in the partnership is an in-kind distribution of additional interests of the second class of partnership interests other than cash.

5. The method of claim 3 comprising the additional steps of:
effecting an in-kind distribution payment from the partnership to the corporation, wherein the in-kind distribution is an additional amount of the second class of partnership interests; and
effecting an in-kind distribution payment from the corporation to the investor in additional shares of the corporation, wherein the amount of the additional shares of the corporation paid to the investor is determined by a ratio of the number of shares issued by the corporation and the number of the second class of partnership interests received by the corporation for the cash investment.
